(19) United States
(12) Patent Application Publication
(10) Pub. No.: US 2002/0004404 A1
(43) Pub. Date: Jan. 10, 2002

(54) Use of local equipment by mobile entity

(75) Inventor: Robert Francis Squibbs, Easter Common (GB)

Correspondence Address: HEWLETT-PACKARD COMPANY, Intellectual Property Administration, P.O. Box 272400, Fort Collins, CO, 80527-2400, US

(73) Assignee: Hewlett-Packard Company

(21) Appl. No.: 09/897,406

(22) Filed: Jul. 3, 2001

(30) Foreign Application Priority Data
Jul. 7, 2000 (GB) 0016756.9

(51) Int. Cl. H04Q 7/20

(52) U.S. Cl. 455/466; 455/414; 455/406

(57) ABSTRACT

A cell phone user wishing to view a web page sends a message containing the URL to a display visible to the user e.g. in a shop window. The web page is displayed and the mobile user is charged an amount by the mobile operator for use of the display, part of this charge being passed on to the shop owner providing the display. The display may display a dynamic code to ensure that only those present can contact the display, and user queue information Other billing arrangements are also provided. Rather than the requested web page (or other information) being displayed, it can be sent to a local printer or other appropriate output device.

### FIELD OF THE INVENTION

The present invention relates to the use of local equipment by a mobile entity, for example for the output of information selected by a mobile entity to a visual display or printer.

### BACKGROUND OF THE INVENTION

Communication infrastructures suitable for mobile users (in particular, though not exclusively, cellular radio infrastructures) have now become widely adopted. Whilst the primary driver has been mobile telephony, the desire to implement mobile data-based services over these infrastructures, has led to the rapid development of data-capable bearer services across such infrastructures. This has opened up the possibility of many Internet-based services being available to mobile users.

By way of example, FIG. 1 shows one form of known communication infrastructure for mobile users providing both telephony and data-bearer services. In this example, a mobile entity 20, provided with a radio subsystem 22 and a phone subsystem 23, communicates with the fixed infrastructure of GSM PLMN (Public Land Mobile Network) 10 to provide basic voice telephony services. In addition, the mobile entity 20 includes a data-handling subsystem 25 interworking, via data interface 24, with the radio subsystem 22 for the transmission and reception of data over a data-capable bearer service provided by the PLMN; the data-capable bearer service enables the mobile entity 20 to communicate with a service system 40 connected to the public Internet 39. The data handling subsystem 25 supports an operating environment 26 in which applications run, the operating environment including an appropriate communications stack.

More particularly, the fixed infrastructure 10 of the GSM PLMN comprises one or more Base Station Subsystems (BSS) 11 and a Network and Switching Subsystem NSS 12. Each BSS 11 comprises a Base Station Controller (BSC) 14 controlling multiple Base Transceiver Stations (BTS) 13 each associated with a respective “cell” of the radio network. When active, the radio subsystem 22 of the mobile entity 20 communicates via a radio link with the BTS 13 of the cell in which the mobile entity is currently located. As regards the NSS 12, this comprises one or more Mobile Switching Centers (MSC) 15 together with other elements such as Visitor Location Registers 32 and Home Location Register 32.

When the mobile entity 20 is used to make a normal telephone call, a traffic circuit for carrying digitised voice is set up through the relevant BSS 11 to the NSS 12 which is then responsible for routing the call to the target phone (whether in the same PLMN or in another network).

With respect to data transmission to/from the mobile entity 20, in the present example three different data-capable bearer services are depicted though other possibilities exist. A first data-capable bearer service is available in the form of a Circuit Switched Data (CSD) service; in this case a fill traffic circuit is used for carrying data and the MSC 32 routes the circuit to an InterWorking Function IWF 34 the precise nature of which depends on what is connected to the other side of the IWF. Thus, IWF could be configured to provide direct access to the public Internet 39 (that is, provide functionality similar to an IAP—Internet Access Provider LAP). Alternatively, the IWF could simply be a modem connecting to a PSTN; in this case, Internet access can be achieved by connection across the PSTN to a standard IAP.

A second, low bandwidth, data-capable bearer service is available through use of the Short Message Service that passes data carried in signalling channel slots to an SMS unit which can be arranged to provide connectivity to the public Internet 39.

A third data-capable bearer service is provided in the form of GPRS (General Packet Radio Service which enables IP (or X.25) packet data to be passed from the data handling system of the mobile entity 20, via the data interface 24, radio subsystem 21 and relevant BSS 11, to a GPRS network 17 of the PLMN 10 (and vice versa). The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the mobile entity 20 can exchange packet data via the BSS 11 and GPRS network 17 with entities connected to the public Internet 39.

The data connection between the PLMN 10 and the Internet 39 will generally be through a firewall 35 with proxy and/or gateway functionality.

Different data-capable bearer services to those described above may be provided, the described services being simply examples of what is possible.

In FIG. 1, a service system 40 is shown connected to the Internet 40, this service system being accessible to the OS/application 26 running in the mobile entity by use of any of the data-capable bearer services described above. The data-capable bearer services could equally provide access to a service system that is within the domain of the PLMN operator or is connected to another public or private data network.

With regard to the OS/application software 26 running in the data handling subsystem 25 of the mobile entity 20, this could, for example, be a WAP application running on top of a WAP stack where “WAP” is the Wireless Application Protocol standard. Details of WAP can be found, for example, in the book “Official Wireless Application Protocol” Wireless Application Protocol Forum, Ltd published 1999 Wiley Computer Publishing. Where the OS/application software is WAP compliant, the firewall will generally also serve as a WAP proxy and gateway. Of course, OS/application 26 can comprise other functionality (for example, an e-mail client) instead of, or additional to, the WAP functionality.

The mobile entity 20 may take many different forms. For example, it could be two separate units such as a mobile phone (providing elements 22-24) and a mobile PC (data-handling system 25) coupled by an appropriate link (wireline, infrared or even short range radio system such as Bluetooth). Alternatively, mobile entity 20 could be a single unit such as a mobile phone with WAP functionality. Of course, if only data transmission/reception is required (and not voice), the phone functionality 24 can be omitted; an example of this is a PDA with built-in GSM data-capable functionality whilst another example is a digital camera (the data-handling subsystem) also with built-in GSM data-capable functionality enabling the upload of digital images from the camera to a storage server.

Whilst the above description has been given with reference to a PLMN based on GSM technology, it will be appreciated that many other cellular radio technologies exist and can typically provide the same type of functionality as described for the GSM PLMN 10.

Recently, there has been increasing interest in providing short-range wireless communication technologies in mobile devices either alone or in conjunction with cellular radio transceivers. A number of technologies exist for the short range communication of information. These technologies include infra-red based technologies and low-power radio technologies (including, in particular, the recent “Bluetooth” short range wireless standard). Depending on the technology implementation, differing types of message propagation will be enabled including asynchronous message broadcast, and multicast and point-to-point duplex connections established after coordination and negotiation between communicating devices.

Another area that has attracted much attention recently is that of “location-aware” services for mobile users, these being services that take account of the current location of the user (or other mobile party). Location-aware services all require user location as an input parameter. A number of methods already exist for determining the location of a mobile user as represented by an associated mobile equipment. Example location-determining methods include the use of GPS systems in mobile equipment, cellular-radio based techniques enabling the location of a mobile device to be determined either in the mobile radio infrastructure or by the mobile device itself, short range beacons transmitting location information to nearby devices, and short-range receivers that can detect nearby devices and establish their location for connected equipment. As can be seen, some of these methods result in the user knowing their location thereby enabling them to transmit it to a location-aware service they are interested in receiving, whilst other of the methods result in the user's location becoming known to a network entity from where it can be supplied directly to a location-aware service. In this latter category are location servers, such as location server 37 of FIG. 1, which provide a focal point for location requests and are operative to ascertain the location of an identified device when requested by using infrastructure resources. Thus, in FIG. 1 the location server 33 services a location request by asking the relevant BSS to carry out a position fix on a target device (for example, by making Timing Advance measurements for three BTSs 13 and using these measurements to derive location, this derivation typically being done in a unit associated with BSC 14). Use of a location server generally requires authorisation from the device user, either on a per request basis or generically in respect of a particular service.

One problem with mobile devices is that the requirement for portability places significant restrictions on the possibilities for information output in visual or hardcopy form. In particular, mobile phones generally have very limited display capability and no hard copy production capability. Of course, many mobile devices do have means by which they can be hooked up to displays and printers when a user is at home or at their workplace. However, there are many occasions when a user does not have access to their own auxiliary display devices and printers.

It is an object of the present invention to facilitate the output of information from a mobile device and, more generally, to facilitate the use of local equipment by a mobile entity.

### SUMMARY OF THE INVENTION

According to the present invention, there is provided an output method for a mobile device that has a cellular-radio transceiver, wherein:

the cellular-radio transceiver sends an identifier of information to be output, via a cellular radio network of a communications infrastructure, to static output equipment local to the mobile device; and

the output equipment uses the identifier to retrieve and output the related information.

According to another aspect of the present invention, there is provided an output system for a mobile device, the system comprising:

a mobile device with a cellular-radio transceiver for sending output requests including an identifier of information to be output;

a communications infrastructure including a cellular radio network with which the mobile device can communicate using its cellular radio transceiver; and

output equipment situated local to the mobile device and comprising:

a communications interface connected to the communications infrastructure for receiving output requests from the mobile device; and

an output device for using a said identifier received in an output request to retrieve and output the related information.

According to a further aspect of the present invention, there is provided output equipment comprising:

a local-code output unit for generating and outputting a time-varying local code;

a communications interface for receiving output requests including an identifier of information to be output and a local-code value;

an output device for using a said identifier received in an output request to retrieve and output the related information; and

a check arrangement for inhibiting operation of the output device in respect of any said output request for which the local-code value included the request does not match the most recent, or one of the most recent, codes output by the local-code output.

### BRIEF DESCRIPTION OF THE DRAWINGS

An output method and system, both embodying the present invention, for the local output of information selected by a mobile entity, will now be described, by way of non-limiting example, with reference to the accompanying diagrammatic drawings, in which:

FIG. 1 is a diagram of a known communications infrastructure usable for transferring voice and data to/from a mobile entity;

FIG. 2 is a diagram of a mobile entity communicating, via a mobile cellular radio network, with a display device provided in a shop window; and

FIG. 3 is a diagram of a mobile entity communicating, via a mobile cellular radio network and an internet service system with a display device provided in a shop window.

### BEST MODE OF CARRYING OUT THE INVENTION

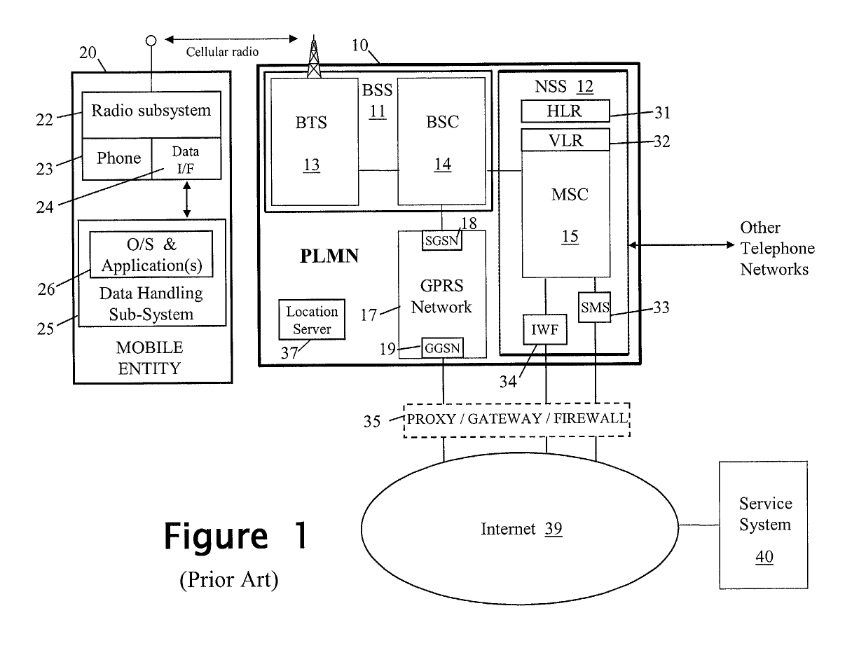

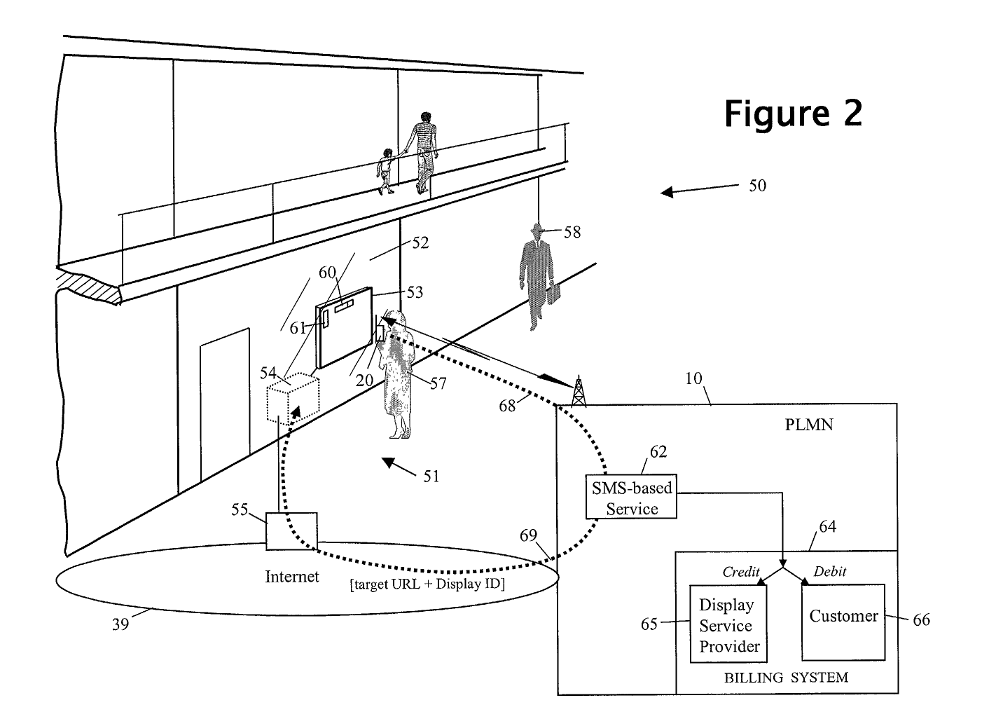

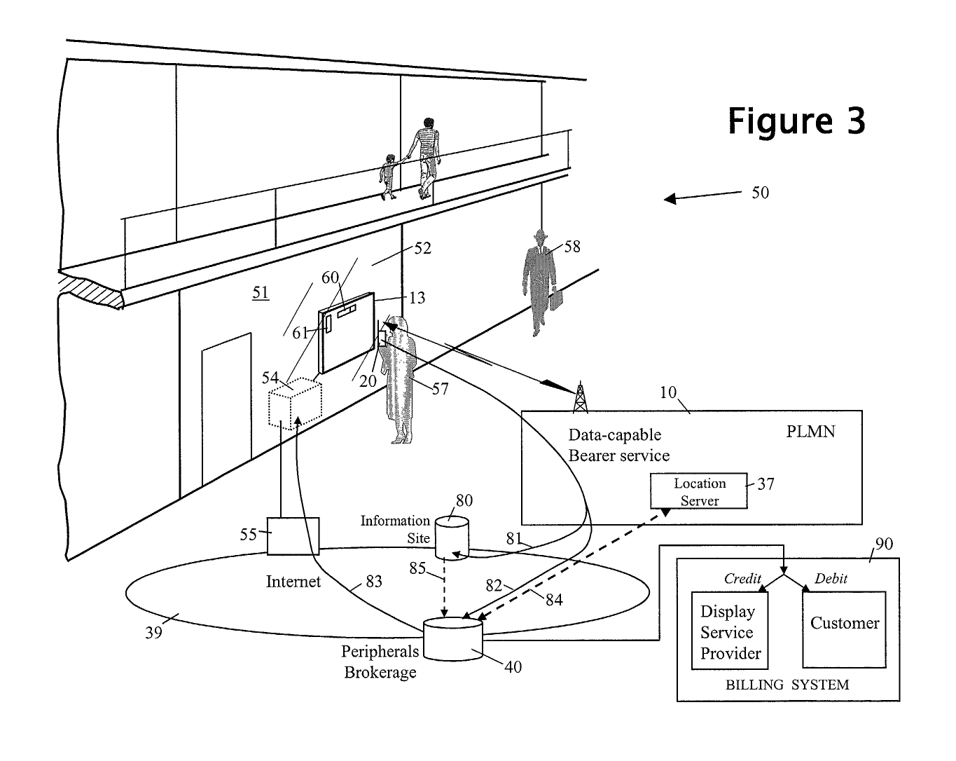

Local-equipment usage methods and systems embodying the invention will now be described with reference to FIGS. 2 and 3. It is to be understood that the present invention is not limited to the specifics of the mobile entity and communication infrastructure shown in FIGS. 2 and 3 and the generalisations discussed above in relation to FIG. 1 regarding these elements apply equally to the described embodiments.

FIG. 2 depicts part of a shopping mall 50 and, in particular, a shop 51 with a display window 52 through which passers-by 57, 58 can see an electronic display 53 (for example, a video monitor or LED display). The display 53 is used both for displaying promotional and other information (generally referred to below as “content”) selected by the shop, and for displaying content provided or selected by passers-by using mobile devices 20. In FIG. 2, passer-by (or “user”) 57 is shown as using the display for viewing content selected by the user, this content being, for example, information held on a particular web page.

More particularly, display 53 is controlled by an associated processor 54 (e.g. a PC) that has internet access via appropriate access means 55 which preferably provide a permanent internet connection. The processor 54 runs browser software enabling it to display, on display 53, web pages retrieved from web servers (not shown) connected to the internet 39.

Mobile device 20 comprises a WAP-enabled cell phone enabling the user to connect to internet websites via a data-capable bearer service of PLMN in the manner outlined above with reference to FIG. 1. The user 57 frustrated by the small size screen display of the device 20, decides that they want to display a particular web page on a larger screen. Since the user is away from their home and office, the user decides to use the display 53.

The user first captures the URL of the desired web page (for example, by saving it as a “favorite”). The user then ascertains a contact number for the display, this number being shown on the display itself, for example in display field 60. This contact number is in the form of a telephone number. The user now composes an SMS (Short Message Service) message that includes the URL of the web page to be displayed—preferably the device 20 includes a utility program for converting the URL of a selected “favorite” into a sequence of numeric keypad key presses suitable for representing the characters of the URL in a standard format, thereby avoiding the need for the user to do this translation.

The user then transmits the SMS message. The message is received by SMS service center 62 of PLMN 10 which recognises the SMS contact number as being one associated with equipment, such as display 53, available for public use. The SMS processor 62 looks up the internet address of the device 53 (or, rather, of processor 54) and then sends on an output request message to the processor 54 via the internet; the message includes the URL of the web page to be displayed. On receiving the output request, processor 54 extracts the URL of the desired web page, fetches the page over the internet and displays it on screen 53. Typically, the web page will be displayed for a fixed period (for example, 60 seconds) with the user being given the opportunity to continue the display for a further period by sending a repeat message. If other output requests have been received by processor 54 and are waiting to be output on screen 53, then any display extension in respect of a particular page is restricted to a maximum period (for example, a maximum extension equal to the initial period); however, if no other requests are pending, then the user is allowed to extend their display period for multiple extension periods.

If there are pending requests these are organised into a queue according to a predetermined queuing regime (typically, though not necessarily, a first come, first served, regime). The current queue status is displayed in display field 61 in the form of a list showing an element of the information to be displayed or of its URL, this element being sufficient to enable a user to identify their request and thus their queue position; in this manner, user identity, even if known to the processor 54, is kept confidential. Rather than using an element related to the information to be displayed to identify the user in the queue list, part of the user's mobile phone number can be used (in which case, service center 62 would need to include this part in the output request), or an identifier (such as a name or number) included for this purpose by the user in their original request.

In order to ensure that only current passers-by use the display 53 and not a remote user who may know the contact number for the display, the processor 54 preferably causes the display to display a code (for example, a three digit code added to the end of the contact number in display field 60), this code changing a regular intervals (for example every minute) in a random manner. The user is required to include this code in their SMS message and the SMS service center 62 passes on the code in the request message to processor 54. Processor 54 compares the received code against the current code (and, preferably against its last two values) and discards any message where a code match is not found. Of course, other methods can be used for locally passing a code from the output equipment (processor 54, display 53) to the mobile device; thus where both the mobile device and output equipment are equipped with short-range communication devices (such as Bluetooth wireless system) them this system can be used to pass on a variable code to the mobile device.

As regards payment for use of the display 53, since the display is used part of the time for promoting the shop 51, the shop management could opt not to charge for the service. However, in the present embodiment a simple arrangement is provided by which the shop can be compensated for the use of display 53 by passers-by. More particularly, since the user 57 already has a billing relationship with the operator of the mobile network 10, it is convenient to arrange for the mobile operator also to bill the user for use of display 53 with the shop owner being appropriately credited for such use. This is done by having the SMS service center 62 notify the billing system 64 of PLMN 10 that not only has a short message been sent by user 57, but also that it relates to the use of equipment of a particular party (the shop owner). The shop owner has a pre-established relationship with the mobile operator, having had to register the display 53 with the latter in order for the output service to be established (registration involves having a contact number assigned and associated with the internet address of processor 54). The billing system 64 of PLMN 10 on notification of the billing details (subscriber identity, output service provider identity) debits the subscriber's account 66 and credits the output service provider's account 65. The subscriber's account can be a pre-pay account, a monthly account or any other type of account. Because each SMS message sent by user 57 for use of the display represents a fixed period of usage, there is no usage-duration metering required.

In view of the limited form of the input device (mobile device 20) and the discrete nature of the communication between the device 20 and processor 54, the display of a follow-on web page by selecting a hyperlink on the currently-displayed web page is not straightforward. In many cases this will not matter as the information of interest to the user will be on the page initially selected for display. However, in order to facilitate selection of hyperlinks by device 20, the processor 54 preferably includes software for scanning a web page, recognising hyperlinks in the page and numbering these links, the allocated number being displayed overlaid on the link. The processor maintains a table for the currently-displayed page associating link number to hyperlink URL. The user 57 can then select a link by including the displayed link number in an SMS message addressed to the processor 54 (advantageously, the number includes a prefix that the processor 54 recognises as indicating that the identified link is to be followed, the processor thereupon retrieving the corresponding URL from the number/URL table and retrieving the required page over the internet).

It will be appreciated that the same arrangement can be used to have selected content output to a local printer or, indeed, for enabling use, and related billing for such use, of any local equipment including a vending machine.

It may be noted that the display screen 53 is located behind the shop window 52 and is physically inaccessible to passers-by. The display is thus secure and can be operated even when the shop is closed. For output devices in the form of printers, it is possible to devise hard-copy output slots that offer security for the printer from passers-by.

The FIG. 3 embodiment, like that of FIG. 2, involves the user 57 communicating using the PLMN 10 rather than by using a short-range link. However, this time the PLMN is simply used to provide a data-capable bearer service providing the user access to the internet (either with the PLMN operator providing such access or with the user connecting through the telephone system to their own Internet Access Provider (not shown). In the present example, the user 57 initially the internet connection to browse internet information site 80 (see arrow 81) through a browser facility of their device 20 (for example using a WAP browser).

The operator of the display 53 is registered with a peripherals brokerage service system 40 that is connected to the internet 39. Other operators of equipment that is available for public use are also registered with the brokerage service 40. Furthermore, in the present example, user 57 is also a registered user of the service 40 and has been allocated a username and password.

When user 57, in the course of browsing site 80, determines that they want to display the page they are currently viewing on display 53, the user captures the URL of the page and sends it to the brokerage service 40 (see arrow 82) together with an identity code of the display 53. Brokerage service 40 first checks the identity of the user (by asking for the user's username and password) and then contacts the processor 54 (arrow 83) to have it display the web page requested by user 57. The brokerage service thus acts as a proxy for the user 57.

Brokerage service 40 runs a billing system 90 similar to the billing system 45 of PLMN 10 whereby the user 57 is debited an amount for use of the display 53 and the shop owner is credited an amount for use of the display, this latter amount generally being less than the former amount so as to provide a revenue stream to the brokerage service.

Rather than the user 57 having to supply an identifier of display 53 to the brokerage service 40, the latter could automatically determine which display is to be used on the basis of the user's current location. This is achieved by the brokerage service 40 contacting a location server of PLMN 10 (see arrow 84) to ascertain the location of device 20 (service 40 being, for example, pre-authorised by user 57 to obtain such location information). To avoid any confusion, the service 40 preferably returns to the user an indication of precise location of the display that the service intends to use - if this location does not match with the user's expectation, the user can cancel the display request.

As another variant, the site 80 can provide on each page a facility for the user 57 to opt to have the page output, the selection of this option causing the site 80 to send the page URL and the current IP address of the user 57 to the brokerage service 40 (see arrow 85), the service 40 then taking over management of the display of the page in the manner described above.

Rather than the brokerage service running its own billing system 90 for charging the user 57 and crediting the shop owner, the service 40 could arrange with the PLMN operator to use the billing system of the latter.

The items of equipment such as display 53 that the user can access, could in fact be provided to shops, such as the shop 51, and other public locations by the brokerage service rather than the shop owners or other bodies. In this case, the brokerage service would take a greater proportion of the revenues generated.

In an alternative financing model it is the sites that register with the brokerage service rather than the user 57, the sites paying a flat rate for the service offered by the brokerage service system whilst the user pays nothing. One advantage of this arrangement is that only approved sites are permitted to use the display 53 so that the risk of offensive material being displayed is reduced.

It will be appreciated that many variants are possible to the above described embodiments. For example, in the FIG. 2 embodiment, the SMS service center is effectively providing an IN (Intelligent Network) service to the user 57 by translating a dialled number to an internet address and effecting a request to that address. This IN service can be implemented by more traditional IN elements of the PLMN or a connected PSTN.

Again with reference to the FIG. 2 embodiment, the user 57 can use the PLMN 10 and the PSTN (Public Switched Telephone Network) to place a telephone call to the shop premises 51 and then use the resultant voice circuit to pass the URL of the page to be displayed. In this case, equipment either in the PLMN or PSTN can be set to recognise the dialled number as one corresponding to a request to use publicly-available equipment of a particular party and effect the appropriate billing operations.

In another variant, the user connects to the processor 54 over the internet with the PLMN simply providing a channel to the user's preferred Internet Access Provider, the latter having a billing relationship with the user and being responsible for recognising that the user is requesting use of publicly-available equipment and for effecting appropriate billing operations.

Where the information to be output is audio in form, then the output equipment takes the form of an audio output device. The output equipment may take other forms as appropriate to the form of the information to be output. The information identifier may take forms other than a URL such as a different address form or item title.

1. An output method for a mobile device that has a cellular-radio transceiver, wherein:
the cellular-radio transceiver sends an identifier of information to be output, via a cellular radio network of a communications infrastructure, to static output equipment local to the mobile device; and
the output equipment uses the identifier to retrieve and output the related information.

2. A method according to claim 1, including effecting measures to ensure that the device, or a person in communication with the user of the mobile device, is local to the output equipment.

3. A method according to claim 2, wherein the output equipment displays or otherwise transmits a code that changes with time, this code being required to be sent by the mobile device to the output equipment which is enabled to output said information only if the code received from the mobile device matches the current or at least a recent value of the code displayed by the equipment.

4. A method according to claim 1, wherein the communications infrastructure ascertains the location of the mobile device and routes said identifier to output equipment known to be local to the location of the mobile device.

5. A method according to claim 1, wherein the communications infrastructure includes the public internet to which the output equipment is connected; the communications infrastructure providing a routing service that translates a destination phone number received from the mobile device into an internet address for the output equipment and forwards on said identifier to the output equipment at said address.

6. A method according to claim 5, wherein the service is provided by a mobile cellular radio network of the communications infrastructure.

7. A method according to claim 6, wherein the service is provided in association with a short-message service of the mobile cellular radio network.

8. A method according to claim 5, wherein:
the communications infrastructure includes the internet, and
the said service is provided by a service provider connected to the internet, said information or identifier being sent from the mobile device through a mobile cellular radio network to the internet and via the latter to the service provider.

9. A method according to claim 1, wherein the communications infrastructure provides a routing service that ascertains the location of the mobile device, determines the closest output equipment suitable for providing an output of a form specified by the mobile device, and sends the identifier to that mobile equipment

10. A method according to claim 9, wherein the service is provided by a mobile cellular radio network of the communications infrastructure.

11. A method according to claim 10, wherein the service is provided in association with a short-message service of the mobile cellular radio network.

12. A method according to claim 9, wherein:
the communications infrastructure includes the internet, and
the said service is provided by a service provider connected to the internet, said information or identifier being sent from the mobile device through a mobile cellular radio network to the internet and via the latter to the service provider.

13. A method according to claim 1, wherein the communications infrastructure provides a proxy service between the mobile device and the output equipment.

14. A method according to claim 13, wherein the service is provided by a mobile cellular radio network of the communications infrastructure.

15. A method according to claim 14, wherein the service is provided in association with a short-message service of the mobile cellular radio network.

16. A method according to claim 13, wherein:
the communications infrastructure includes the internet, and
the said service is provided by a service provider connected to the internet, said information or identifier being sent from the mobile device through a mobile cellular radio network to the internet and via the latter to the service provider.

17. A method according to claim 1, wherein the user of the mobile device has a pre-existing billing relation with the cellular radio network, the cellular network providing a billing service for billing use of the output equipment to the user of the mobile device.

18. A method according to claim 1, wherein the communications infrastructure includes the internet, said identifier being sent from the mobile device through the cellular radio network to the internet and via the latter to the output equipment, an operator of a component of the communications infrastructure other than of the cellular radio network, having a pre-existing billing relation with the user and providing a billing service for billing use of the output equipment to the user of the mobile device.

19. A method according to claim 1, wherein said identifier of information is a web page address, the output equipment fetching the web page over the public internet.

20. A method according to claim 1, wherein the output equipment is a visual display.

21. A method according to claim 19, wherein the output equipment is a visual display.

22. A method according to claim 1, wherein the output equipment is a printer.

23. A method according to claim 19, wherein the output equipment is a printer.

24. A method according to claim 1, wherein the output equipment is physically isolated from the user of the mobile device.

25. A method according to claim 24, wherein the output equipment is a visual display device situated behind a shop-front window.

26. An output system for a mobile device, the system comprising:
a mobile device with a cellular-radio transceiver for sending output requests including an identifier of information to be output;
a communications infrastructure including a cellular radio network with which the mobile device can communicate using its cellular radio transceiver; and
output equipment situated local to the mobile device and comprising:
a communications interface connected to the communications infrastructure for receiving output requests from the mobile device; and
an output device for using a said identifier received in an output request to retrieve and output the related information.

27. An output system according to claim 26, wherein the output equipment further comprises:
a local-code output unit for generating and outputting a time-varying local code;
a check arrangement for inhibiting operation of the output device in respect of any said output request that does not include a local-code value matching the most recent, or one of the most recent, codes output by the local-code output.

28. An output system according to claim 26, wherein the output equipment is a visual display.

29. An output system according to claim 26, wherein the output equipment is a printer.

30. An output system according to claim 26, wherein said identifier of information is a web page address, the output equipment fetching the web page over the public internet.

31. An output system according to claim 26, wherein the communications infrastructure includes location discovery means for ascertaining the location of the mobile device and routing means for routing said output request to output equipment known to be local to the location of the mobile device.

32. An output system according to claim 26, wherein the communications infrastructure includes the public internet to which the output equipment is connected; the communications infrastructure further including a routing arrangement that translates a destination phone number received from the mobile device in association with a said output request into an internet address for the output equipment and forwards on said output request to the output equipment at said address.

33. Output equipment comprising:
a local-code output unit for generating and outputting a time-varying local code;
a communications interface for receiving output requests including an identifier of information to be output and a local-code value;
an output device for using a said identifier received in an output request to retrieve and output the related information; and
a check arrangement for inhibiting operation of the output device in respect of any said output request for which the local-code value included the request does not match the most recent, or one of the most recent, codes output by the local-code output.

34. Output equipment according to claim 33, wherein the output equipment is a visual display.

35. Output equipment according to claim 33, wherein the output equipment is a printer.

36. Output equipment according to claim 33, wherein said identifier of information is a web page address, the output equipment fetching the web page over the public internet.

37. Output equipment according to claim 33, wherein the local-code output unit includes a visual display for displaying the current local code. Value.
